(19) United States
(12) Patent Application Publication
(10) Pub. No.: US 2026/0314617 A1
(43) Pub. Date: Oct. 15, 2026

(54) PLANT-BASED MILK STORAGE

(71) Applicant: XHEME, INC., Newton, MA (US)

(72) Inventor: Siva Sai Ramana Kumar CHALLA, Newton, MA (US)

(21) Appl. No.: 19/462,044

(22) Filed: Jan. 28, 2026

Related U.S. Application Data
(60) Provisional application No. 63/750,840, filed on Jan. 29, 2025.

(51) Int. Cl. A23B 11/10; B65D 65/42; B65D 81/28; B65D 85/80; C08K 3/22; C08K 7/18; C08K 7/24; C09D 1/00

(52) U.S. Cl. CPC A23B 11/10; B65D 65/42; B65D 81/28; B65D 85/80; C08K 3/22; C08K 7/18; C08K 7/24; C09D 1/00; C08K 2003/2213; C08K 2003/2244; C08K 2201/003; C08K 2201/011

(57) ABSTRACT

Cerium oxide and zirconium dioxide films and containers for the storage of plant-based milk. More specifically, cerium oxide nanoparticles and/or nanoporous cerium oxide nanoparticle macro-structures and/or zirconium dioxide nanoparticles are dispersed within or coated onto a polymeric film or other substrate material which may be in the form of a container for storage and increased shelf-life of plant-based milk.

### FIELD

The present disclosure is directed at cerium oxide and zirconium dioxide films and containers for the storage of plant-based milk. More specifically, cerium oxide nanoparticles and/or nanoporous cerium oxide nanoparticle macro-structures and/or zirconium dioxide nanoparticles are dispersed within or coated onto a polymeric film or coated onto another suitable substrate which may be in the form of a container for storage and increased shelf-life of plant-based milk.

### BACKGROUND

The growing demand for almond milk and other plant-based milks (such as oat, soy, and rice milk) has led to innovations in storage technologies focused on maintaining quality, extending shelf life, and preventing spoilage. One key challenge in storing plant-based milks, especially those derived from nuts, is lipid oxidation, which can degrade flavor, aroma, and nutritional quality. Exposure to oxygen during storage can lead to oxidation, which degrades fats, vitamins, and flavor compounds. Packaging innovations, such as nitrogen flushing or vacuum-sealed containers, may reduce oxygen exposure and prolong freshness.

Lipid oxidation is a major issue, particularly for almond milk, which contains a relatively high percentage of unsaturated fats. Oxidation can lead to the development of off-flavors (rancidity), loss of nutritional value, and degradation of shelf life. Adding natural antioxidants (such as tocopherols or rosemary extract) may slow down the oxidation process. Improved packaging solutions, such as oxygen-impermeable and light-blocking materials, may also minimize oxidation. The use of natural antioxidants, such as vitamin E, rosemary extract, or tocopherols, is being explored to counteract lipid oxidation. Antioxidants may protect against the degradation of unsaturated fats, preserving the sensory and nutritional quality of plant-based milks over time. These natural preservatives may also meet consumer demand for clean-label products. However, formulating plant-based milks with effective concentrations of antioxidants without impacting taste or texture remains a challenge. Additionally, natural antioxidants may not completely prevent oxidation over extended storage periods.

Plant-based milk under storage is reported to cause lipid peroxidation due to the production of peroxide-based chemicals or in general Reactive Oxygen Species (ROS). Accordingly, a need exists to provide storage solutions that more effectively control oxygen from ROS or scavenge the free radicals, and in particular mediums that convert the hydrogen peroxide and/or ROS to oxygen, to mitigate lipid peroxidation and to increase shelf-life. A need also exists for storage solutions with relatively high shelf life without the need to add additional preservatives.

### SUMMARY

A method of increasing the shelf life of plant-based milk in a container comprising: (a) providing a container comprising polymeric film containing at least one of cerium oxide nanoparticles, nanoporous cerium oxide nanoparticle macro-structures, or zirconium dioxide nanoparticles; and (b) storing plant-based milk in said container.

A method of storing plant-based milk providing a container comprising polymeric film, metal or paperboard including a contact layer having at least one of cerium oxide nanoparticles, nanoporous cerium oxide nanoparticle macro-structures, or zirconium dioxide nanoparticles and storing plant-based milk in said container in contact with said contact layer.

A method of storing plant-based milk comprising (a) providing a container comprising polymeric film including a polymeric film insert having at least one of cerium oxide nanoparticles, nanoporous cerium oxide nanoparticle macro-structures, or zirconium dioxide nanoparticles; and (b) storing plant-based milk in said container in contact with said insert.

A container for plant-based milk comprising a plant-based milk storage surface comprising at least one of cerium oxide nanoparticles, nanoporous cerium oxide nanoparticle macrostructures or zirconium dioxide nanoparticles present in an amount effective to increase the shelf-life of plant-based milk when plant-based milk is stored in contact with the plant-based milk storage surface.

### BRIEF DESCRIPTION OF THE DRAWINGS

Aspects of the present disclosure may be appreciated upon review of the description herein and the accompanying drawings which identify as follows:

FIG. 1 illustrates cerium oxide nanoparticles;

FIG. 2 illustrates the nanoporous cerium oxide nanoparticle (NCeONP) macro-structure formed from the cerium oxide nanoparticles illustrated in FIG. 1;

FIG. 3 is a scanning electron micrograph of the cerium oxide nanoparticles employed to form the nanoporous cerium oxide nanoparticle macro-structure;

FIG. 4A is a scanning electron micrograph of the nanoporous cerium oxide nanoparticle macro-structure at the indicated magnification;

FIG. 4B is another scanning electron micrograph of the nanoporous cerium oxide nanoparticle macro-structure at the indicated magnification;

FIG. 4C is another scanning electron micrograph of the nanoporous cerium oxide nanoparticle macro-structure at the indicated magnification;

FIG. 5 is a plot of lipid peroxidation levels of almond milk evaluated at 4 °C over a 12 day period for single layer polyolefin control film, polyolefin containing a 1.5% (wt.) loading of 1:1 mixture of NCeONP/ZrO₂ additive (i.e. nanoporous cerium oxide macrostructures and zirconium oxide particles), and a film from a human breast milk container sold in the market by Medela;

FIG. 6 is a plot of lipid peroxidation levels of almond milk evaluated at room temperature over a 48 hour period for multilayer polyolefin control film, a multilayer polyolefin film having a contact layer of polyolefin film containing a 1.5% (wt.) loading of 1:1 mixture of NCeONP/ZrO₂ additive (i.e. nanoporous cerium oxide macrostructures and zirconium oxide particles), and a film from a human breast milk container sold in the market by Medela;

FIG. 7 is a plot of liquid peroxidation in the indicated plant-based milk containers produced from single layer films generated from polyethylene-co-vinyl acetate (EVA) with a 1.5% (wt.) loading of 1:1 mixture of NCeONP/ZrO₂ additive versus a control film and a film from a human breast milk bag sold in the market by Medela;

FIG. 8 is a plot of liquid peroxidation in the indicated plant-milk containers produced from single layer films generated from polyolefin (ethylene-octene copolymer) with a 2.5% (wt.) loading of 1:1 mixture of NCeONP/ZrO₂ additive (i.e. nanoporous cerium oxide macrostructures and zirconium oxide particles) compared with a corresponding neat polyolefin film without NCeONP/ZrO₂ and a film from a human breast milk bag sold in the market by Medela;

FIG. 9 is a plot of liquid peroxidation of the indicated plant-based milk containers produced from a multilayer film of polyolefin/PE/PP with a 5.0 % (wt.) loading of 1:1 mixture of NCeONP/ZrO₂ (i.e. nanoporous cerium oxide macrostructures and zirconium oxide particles) only in the contact layer versus the corresponding film without additive and a film from a human breast milk bag sold in the market by Medela. The polyolefin comprised ethylene-octene copolymer;

FIG. 10 is a plot of liquid peroxidation of the indicated plant-based milk containers produced from multi-layer films generated from polyolefin/PE/PP with a 1.0% loading of 1:1 mixture of NCeONP/ZrO₂ (i.e. nanoporous cerium oxide macrostructures and zirconium oxide particles) only in the contact layer as compared with the corresponding film without the additive and a film from a human breast milk bag sold in the market by Medela. The polyolefin comprised ethylene-octene copolymer;

FIG. 11 is a plot of liquid peroxidation of the indicated plant-based milk containers produced from single layer films generated from EVA (Ethylene Vinyl Acetate) with a 1.5% (wt.) loading of 1:1 mixture of NCeONP/ZrO₂ additive (i.e. nanoporous cerium oxide macrostructures and zirconium oxide particles) as compared to a corresponding EVA film without NCeONP/ZrO₂ and a film from a human breast milk bag sold in the market by Medela;

FIG. 12 is a plot of liquid peroxidation of the indicated plant-based milk containers produced from a multilayer film generated from polyolefin with a 1.0 % (wt.) loading of 1:1 mixture of NCeONP/ZrO₂ additive (i.e. nanoporous cerium oxide macrostructures and zirconium oxide particles) as compared with a corresponding neat polyolefin film without NCeONP/ZrO₂ and a film from a milk container (Medela) sold in the market. The polyolefin comprised ethylene-octene copolymer.

### DETAILED DESCRIPTION

The present invention stands directed at cerium oxide nanoparticles and/or nanoporous cerium oxide nanoparticle macro-structures and/or zirconium dioxide nanoparticles which individually or in combination can produce oxygen upon exposure to reactive oxygen species (ROS) and/or scavenge free radicals and/or reduce lipid peroxidation. In one embodiment, polymeric films containing cerium oxide nanoparticles and/or nanoporous cerium oxide nanoparticle macro-structures and/or zirconium dioxide nanoparticles may now be relied upon to reduce lipid peroxidation or scavenge free-radicals when such films are brought into contact with plant-based milk, which therefore provides a plant-based milk storage surface. Such films may also preferably be configured to serve as a container for plant-based milk. Or, the polymer film containing cerium oxide nanoparticles and/or nanoporous cerium oxide nanoparticle macro-structures and/or zirconium dioxide nanoparticles may serve as the internal contact layer (storage surface) of the plant-based milk container. The container can take on a number of forms, such as cartons, bags, jugs, etc. Plant-based milk herein is reference to a milk alternatives prepared from plants. Typical plant-based milks therefore include but are not limited to almond milk, coconut milk, oat milk, cashew milk, rice milk and soy milk.

It is contemplated that the cerium oxide nanoparticles and/or nanoporous cerium oxide nanoparticle macro-structures and/or zirconium dioxide nanoparticles produce oxygen from reactive oxygen species produced by plant-milk on storage, such as hydrogen peroxide produced by cells under environmental stress. Reactive oxygen species (ROS) such as superoxide anion (O₂⁻), hydrogen peroxide (H₂O₂) and hydroxy radical (HO●) are understood herein to comprise non-radical oxygen species and radical oxygen species formed by partial reduction of oxygen. By way of further example, reactive oxygen species is therefore reference to oxygen hydroxyl radicals (●OH), hydroxyl ion (OH⁻) superoxide anion radical (●O₂⁻), hydrogen peroxide (H₂O₂), oxygen (O₂), or superoxide anion (O₂^{·-}). The cerium oxide nanoparticles, nanoporous cerium oxide nanoparticle macro-structures, and/or zirconium dioxide nanoparticles may be used as polymer composite films when in contact with plant-based milk to produce oxygen from reactive oxygen species and/or scavenge the presence of free radicals thereby preventing the oxidation of lipids, or as noted, the film itself may be utilized to form the storage container to contain the milk.

The plant-milk storage containers herein that contain cerium oxide nanoparticles, nanoporous cerium oxide nanoparticle macro-structures, and/or zirconium dioxide nanoparticles may preferably have a size in the range of 100 ml to 100 liters. Increased shelf life herein is a reference to a decrease in lipid peroxidation of the plant-milk lipids as a result of using films in contact with the plant-based milk where the films contain cerium oxide nanoparticles, nanoporous cerium oxide nanoparticle macro-structures, and/or zirconium dioxide nanoparticles

When the preferred cerium oxide nanoparticles, nanoporous cerium oxide nanoparticle macro-structures, and/or zirconium dioxide nanoparticles are each on their own dispersed as an additive into a polymeric film that may be used as an insert within the storage container, or even to form the storage container itself, the loading level in the film of the individual additive on its own is preferably in the range of 0.01 wt. % to 10.0 wt. %, more preferably 0.01 wt. % to 5.0 wt. %. Accordingly, one may preferably utilize 0.01 wt. % to 10.0 wt. % of cerium oxide nanoparticles, or 0.01 wt. % to 10.0 wt. % of nanoporous cerium oxide nanoparticle macro-structures, or 0.01 wt. % to 10.0 wt. % of zirconium dioxide nanoparticles in a polymer film that may be used within the storage container or as the polymeric film that forms the container. In addition, when two or more of the cerium oxide nanoparticles, nanoporous cerium oxide nanoparticle macro-structures and zirconium dioxide nanoparticles are present in the polymer film, the combined loading level is also preferably in the range of 0.01 wt. % to 10.0 wt. %. Accordingly, if cerium oxide nanoparticles, nanoporous cerium oxide nanoparticle macro-structures and zirconium dioxide nanoparticles are all present in the polymer film, the combined loading is also preferably in the range of 0.01 wt. % to 10.0 wt. %.

As may therefore be appreciated, the polymer film containing the cerium oxide nanoparticles and/or nanoporous cerium oxide nanoparticle macro-structures and/or zirconium dioxide nanoparticles, or any combination thereof, can physically serve as the storage container for the plant-based milk. The films therefore containing such cerium oxide nanoparticles and/or nanoporous cerium oxide nanoparticle macro-structures and/or zirconium dioxide nanoparticles can similarly produce oxygen from reactive oxygen species and/or scavenge the free radicals that are produced by the lipids or plant-milk on storage and released into the media within the storage container.

Reference to cerium oxide nanoparticles is reference to nanoparticles (NP) preferably having a diameter (largest linear dimension) in the range of 10.0 nm to 100.0 nm, including all individual values and increments therein. Accordingly, the cerium oxide nanoparticles employed herein preferably have a diameter in the range of 10.0 nm to 50.0 nm or 10.0 nm to 30.0 nm or 20.0 nm to 30.0 nm. The zirconium dioxide nanoparticles preferably have a diameter in the range of 10.0 nm to 2000.0 nm. More preferably, the zirconium dioxide particles have a diameter in the range of 10.0 nm to 100.0 nm, or 10.0 nm to 50.0 nm, or 10.0 nm to 20.0 nm, or 10.0 nm to 15.0 nm.

Reference to a nanoporous cerium oxide nanoparticle macro-structure is a reference to the feature that a plurality of the particles associate or adhere to one another where the macro-structure has its own pore size diameter. The above-referenced cerium oxide nanoparticles are therefore preferably degassed with nitrogen for a preferred period of 30 minutes to 60 minutes. This is then preferably followed by heating at elevated temperature, and preferably at the temperature range of 50 °C to 900 °C for a preferred period of 1.0 hour to 3.0 hours, more preferably 1.0 hour to 2.0 hours. Accordingly, such heating of the cerium oxide nanoparticles was observed to form a plurality of nanoporous cerium oxide nanoparticle macro-structures 12 illustrated in FIG. 2 having macro-structure pores 14.

The macro-structure pores 14 that are formed by the cerium oxide nanoparticle macro-structure 12 preferably have a diameter (largest linear dimension) as indicated by arrow 15 in the range of 10 nm to 1100 nm, more preferably, 10 nm to 750 nm or 10 nm to 500 nm or 10 nm to 250 nm or 10 nm to 100 nm or 10 nm to 50 nm or 10 nm to 25 nm. In addition, the nanoporous cerium oxide nanoparticle macro-structures 12 themselves are contemplated to have a preferred diameter (largest linear dimension) as indicated by arrow 16 in the range of 50 nm to 30,000 nm.

In one particularly preferred embodiment, the nanoporous cerium oxide nanoparticle macro-structures that are formed (herein abbreviated as NCeONP or NCeONP macro-structures) have a binary size distribution with respect to both their macro-structure diameter 16 and macro-structure pore diameter 15. A binary size distribution is reference to two distributions of size ranges for both the macro-structure diameter and macro-structure pore diameter. That is, the preparation methods herein preferably provide a nanoporous cerium oxide nanoparticle macro-structure that has the following binary size distribution: (1) macro-structure diameter in the range of 10 nm to 300 nm with a macro-structure pore diameter in the range of 5 nm to 30 nm, more preferably 10 nm to 20 nm; and (2) macro-structure diameter in the range of 5,000 nm to 30,000 nm with a macro-structure pore diameter in the range of 900 nm to 1100 nm.

In another particularly preferred embodiment, one may employ a 1:1 mixture of cerium oxide nanoparticles with zirconium dioxide nanoparticles. However, in the broad context of the present disclosure this ratio can fall in the range of 1:10 to 10:1. Similarly, in preferred embodiment, one may employ a 1:1 mixture of cerium oxide nanoparticles with zirconium dioxide nanoparticles. Moreover, in the broad context of the present disclosure, this ratio of the nanoporous cerium oxide nanoparticle macro-structures to the zirconium dioxide nanoparticles can similarly fall in the range of 1:10 to 10:1, and in in one particularly preferred embodiment, the ratio is a 1:1 mixture of nanoporous cerium oxide nanoparticle macro-structures to zirconium oxide nanoparticles. It is therefore understood that the plant-milk storage container herein provides these aforementioned preferred levels of cerium oxide nanoparticles to zirconium dioxide nanoparticles as well as the preferred levels of nanoporous cerium oxide nanoparticle macro-structures to zirconium dioxide nanoparticles.

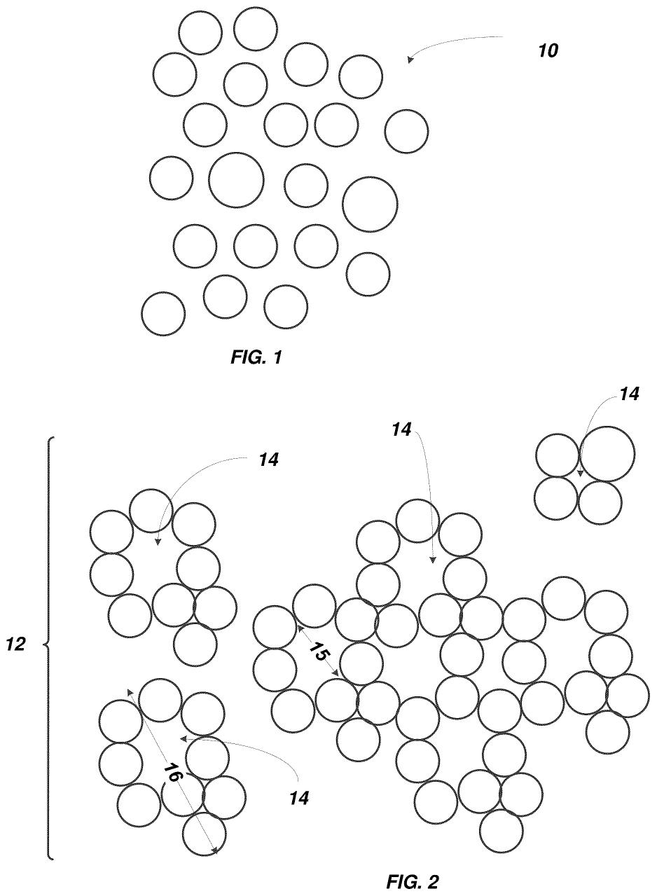

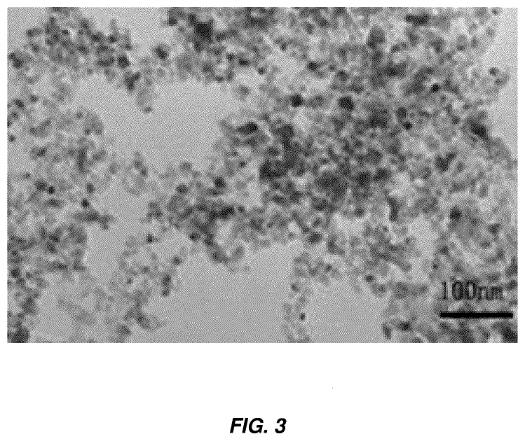

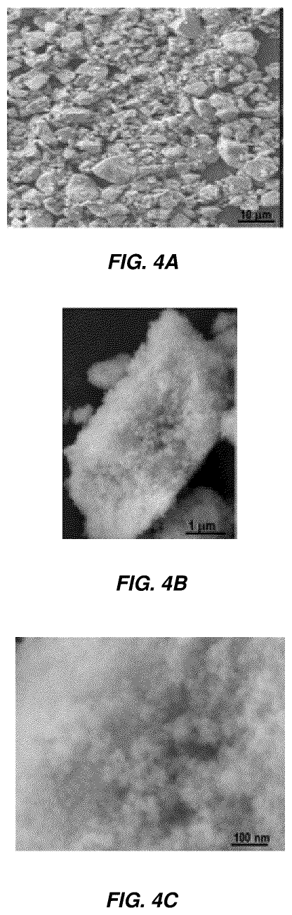

FIG. 3 is a scanning electron micrograph of the cerium oxide nanoparticles employed herein to form the nanoporous cerium oxide nanoparticle macro-structure. As noted above, such starting cerium oxide nanoparticles may preferably have a diameter of 20 nm to 30 nm. FIGS. 4A, 4B and 4C, respectively, provide scanning electron micrographs at increasing magnification showing the nanoporous cerium oxide nanoparticle macro-structure herein formed from the cerium oxide nanoparticles of FIG. 3, wherein the macro-structure itself forms macro-structure pores 14 (see again FIG. 1).

The cerium oxide nanoparticles and/or the nanoporous cerium oxide nanoparticle macro-structures (NCeONP) and/or the zirconium dioxide nanoparticles may therefore preferably be incorporated into a polymer film, which film is then preferably for use to contact or contain the plant-based milk where the polymer film is capable of: (1) converting reactive oxygen species such as hydrogen peroxide to oxygen to mitigate oxidative stress on the cells and to increase cell viability; and/or (2) scavenge free radicals and/or (3) prevent lipid peroxidation. The polymer film is contemplated to include both thermoplastic and thermoset type polymer film. Preferably, the polymer film includes poly(vinyl chloride), and in particular, polyvinyl chloride film that does not contain any plasticizers, and in particular, does not contain phthalate plasticizers. The polymer film may also include polyolefin films, including polyethylene and polypropylene film as well as ethylene-propylene copolymers or ethylene-octene copolymer. Other polymer films may include polyethylene-co-vinyl acetate (EVA) polymeric films, polyester films (e.g., PET), polyamide films, cellulosic films, polylactic acid (PLA), polysiloxane films (e.g., polydimethylsiloxane (PDMS) films), aromatic polyketone films (e.g., PEEK), polyimide films, hydrogel films, and polyurethane films.

These polymer films can be single layer or multiple layers with the layer that is in contact with the fluid (plant milk) embedded or coated with cerium oxide nanoparticles and/or nanoporous cerium oxide nanoparticle macro-structures and/or zirconium dioxide nanoparticles. Such polymer films may therefore be preferably employed to form the plant-based milk bag and the films may be single layer films or multilayer films where the film loaded with cerium oxide nanoparticles and/or the nanoporous cerium oxide nanoparticle macro-structures and/or zirconium dioxide nanoparticles preferably serve as the internal or contact layer in contact with the plant-based milk. The polymer films also preferably have a thickness in the range of 10.0 microns to 10.0 mm, including all values and increments therein. Accordingly, in a multiple layer film herein, all of the individual layers including the contact layer may preferably have a thickness in the range of 10.0 microns to 10.0 mm.

As alluded to above, the polymer films (whether placed within a milk container or to form the container itself) preferably have an individual loading level of cerium oxide nanoparticles or the nanoporous cerium oxide nanoparticle macro-structures or zirconium dioxide nanoparticles at a level in the range of 0.01 wt. % to 10.0 wt. %, including all values and increments therein. In addition, the cerium oxide nanoparticles, nanoporous cerium oxide nanoparticle macro-structures and zirconium dioxide nanoparticles may be selectively mixed and similarly be preferably present in the polymer film at a combined and maximum loading level of 0.01 wt. % to 10.0 wt. %. In other words, as mixed together, two or more of the cerium oxide nanoparticles or the nanoporous cerium oxide nanoparticle macro-structures or zirconium dioxide nanoparticles are preferably present at a combined loading level that totals 0.01 wt. % to 10.0 wt. %. For example, when the load level is set to the 10.0 wt. % maximum, the level of cerium oxide nanoparticles may preferably be 3.0 wt. %, the level of cerium oxide macro-structures may be 5.0 wt. % and the level of zirconium dioxide nanoparticles may be 2.0 wt. %.

Expanding upon the above, it can now be appreciated that the zirconium dioxide nanoparticles may replace a portion of the cerium oxide nanoparticles or nanoporous cerium oxide nanoparticle macro-structures. In the preferred case of film loadings, and by way of further example, the zirconium dioxide nanoparticles may therefore preferably be present with the cerium oxide nanoparticles and/or cerium oxide macro-structures at a level of up to 9.9 wt. % to 0 wt. %. For example, the loading level of zirconium dioxide nanoparticles in the polymer film may preferably be 9.9 wt. % and the level of cerium oxide nanoparticles and/or cerium oxide macro-structures is then 0.1 wt. %, so a combined and total loading level in the polymer film is 10.0 wt. %. Or, in another example, the level of cerium oxide nanoparticles and/or nanoporous cerium oxide macro-structures in a polymer film may be at a level of 5.0 wt. % and the level of zirconium dioxide nanoparticles may be in the range of 0.1 wt. % to 5.0 wt. %. In yet another example, the level of cerium oxide nanoparticles and/or nanoporous cerium oxide macro-structures in a polymer film may be 7.0 wt. % and the level of zirconium dioxide nanoparticles may be in the range of 0.1 wt. % to 3.0 wt. %.

The above referenced polymer films (without any loaded amounts of cerium oxide nanoparticles or nanoporous cerium oxide nanoparticle macro-structures or zirconium dioxide) may also preferably be coated with the cerium oxide nanoparticles and/or the nanoporous cerium oxide nanoparticle macro-structures (NCeONP) and/or the zirconium dioxide nanoparticles. In addition, when coating with the cerium oxide nanoparticles and/or the nanoporous cerium oxide nanoparticle macro-structures and/or the zirconium dioxide nanoparticles, one may utilize as a substrate for coating a non-polymeric material such as metals including aluminum or stainless steel or even a coating on paper-board.

Such coating on polymer films or on metal or on paperboard may therefore also serve as the internal surface of the container for the plant-based milk, namely that surface that is in contact with a given plant-based milk which can be referred to as the contact layer. Such coating may be achieved by preparing formulations containing the cerium oxide nanoparticles and/or the nanoporous cerium oxide nanoparticle macro-structures (NCeONP) and/or the zirconium dioxide nanoparticles along with coating polymers in solvents followed by coating of the formulation on the surface of the film and allowing it to dry. It is contemplated that such coating polymers preferably comprise thermoplastic polymers that are soluble in selected solvent(s) that are suitable for coating purposes. The loading of coating polymer in the solvent may preferably be in the range of 0.01 wt. % to 10.0 wt. % and the loading level of any one or more of the cerium oxide nanoparticles or the nanoporous cerium oxide nanoparticle macro-structures (NCeONP) or the zirconium dioxide nanoparticles in the solvent may therefore preferably be in the range of 0.01 wt. % to 10.0 wt. %. Moreover, the loading level of any two of the cerium oxide nanoparticles and/or the nanoporous cerium oxide nanoparticle macro-structures (NCeONP) and/or the zirconium dioxide nanoparticles in the solvent may preferably provide a total loading the range of 0.01 wt. % to 10.0 wt. %. In addition, the loading level of all three of the cerium oxide nanoparticles and/or the nanoporous cerium oxide nanoparticle macro-structures (NCeONP) and the zirconium dioxide nanoparticles in the solvent may also preferably total in the range of 0.01 wt. % to 10.0 wt. %. The coating thickness (on the polymeric film or metal or paper-board) is preferably in the range of 0.01 microns to 1000 microns.

It should now be appreciated that one can utilize a single or multi-layer polymer film construction for the formation of the plant-based milk storage container, where in the case of a single layer polymer film, the film is coated or embedded with the aforementioned additives. Or, in the case of a multilayer film, only that layer in contact with the plant-based milk is loaded or coated with the aforementioned additives. Even further, one may utilize a metal or paper-board substrate, in the form of a container that is then configured to have a polymer film contact layer containing the aforementioned additives or a coating layer sourced from application of a coating polymer again containing the aforementioned additives. Such containers are therefore configured to contain plant-based milk that can undergo lipid peroxidation on storage, wherein reactive oxygen species such as hydrogen peroxide present or produced in the liquid media can be converted to oxygen and/or the films or coatings containing cerium oxide nanoparticles and/or nanoporous cerium oxide nanoparticle macro-structures and/or zirconium dioxide nanoparticles scavenge free radicals. As noted, the films may therefore preferably be in the form of a container. The polymer films forming the container are therefore contemplated to reduce the environmental stress on the plant-based milk, and particularly lipids therein due to the presence or production of, e.g., hydrogen peroxide within the container. This is particularly contemplated to improve shelf life of plant-based milk on storage either at room temperature or in a refrigerated environment (e.g., at or below 40 °F or more preferably in the range of 35 °F to 38 °F).

In connection with the use of the additives herein either embedded and mixed within a given polymeric film, or serving as a coating on a polymeric film, metal or paperboard surface, such containers may optionally be used in the presence of preservatives. A preservative may therefore be understood as any chemical compound added directly to the plant-based milk to further extend the shelf-life. Such preservatives may include in the case of almond milk, preservatives such as lecithin to maintain oil-water stability, gellan fum to provide suspension and relatively improved texture, locust beam gum to prevent phase separation, xantham gum to stabilize texture and avoid sedimentation and d-alpha-tocopherols as a natural antioxidant. In the case of oat milk, the additional stabilizers that may be employed similarly include lecithin, gellan gum, locust bean gum, diphosphates to prevent phase separation and ascorbic acid to protect freshness from oxidative damage.

### Working Examples

Example 1: Single layer polymer composite films were prepared from ethylene vinyl acetate (EVA) or polyolefins (PO) (e.g., ethylene-octene copolymer) that contained 0.5-5.0 wt. % of a 1:1 mixture of nanoporous cerium oxide nanoparticle macro-structures in combination with zirconium dioxide nanoparticles. One can directly mix the 1:1 mixture of nanoporous cerium oxide nanoparticle macro-structures in combination with zirconium dioxide nanoparticles with the molten EVA or PO to extrude or compression mold into nanocomposite films preferably using a twin screw extruder. Screw configuration, feed rates of the EVA or PO and NCeONP/ZrO₂, and screw speed control the rates of shear and elongation applied to the nanocomposite and the residence time in the extruder. The nanocomposite films with different concentrations of NCeONP/ZrO₂ were prepared, namely 0.5%, 1%, 1.5%, 2.0 wt. %, 2.5% and 5.0 wt. %.

Example 2: Multilayer composite films were prepared through co-extrusion and ensuring that the NCeONP/ZrO₂ particles were only present in the contact layer film that is exposed to the plant-milk.

Example 3: Preparation of Fresh Almond Milk: Almond milk was prepared in the laboratory using a 1:1 ratio of commercially purchased almonds (nuts) to water, ensuring consistency and quality and using the following method: First, soak 1 cup (140 g) of unroasted & unsalted almonds in at least 3 cups of DI water in a glass beaker. Cover it with aluminum foil to prevent oxidation. Place the beaker in 4 C. Let it soak for at least 12-16 hours. Soaking softens the almonds and helps to activate enzymes that improve digestibility and nutrient availability. After soaking, drain the almonds and rinse them thoroughly to remove any phytic acid and tannins released during soaking. Remove the skin of the almonds. Combine the almonds with DI water in a blender or food processor in a 1:1 ratio (cups). Example: 1 cup of almonds (140 g) is blended with 1 cup of DI water (240 ml). Blend at a high speed for 2-3 minutes until the mixture appears creamy and smooth, with no large almond pieces remaining. Double strain the milk from the mixture using two nut milk bags (180 um pore size).

Example 4: TBARS Assay for measuring the level of lipid peroxidation in almond milk using the Thiobarbituric Acid Reactive Substances (TBARS) assay:

Part A: Ready a water bath at 100 °C. Prepare 100 ml of Thiobarbituric Acid (TBA) solution. Dissolve 0.67 g of TBA in 10 ml of DMSO in a conical flask. Add 80 ml of H₂O to a glass bottle. Add prepared TBA to the glass bottle. Dissolve 15 g of trichloroacetic acid (TCA) in the glass bottle. Swirl until dissolved. Add 4.68 ml of 12N HCl. Bring the volume up to 100 ml with DI water if needed. Prepare 500 uM malondialdehyde (MDA) Stock. Add 4.167 uL of MDA to 1 ml ethanol in a glass bottle. Add 49 ml of H2O to this.

Part B: Preparation of 8 MDA Standards in microfuge tubes: Prepare 8 falcon tubes for the standards and the required number of tubes for samples. Add 2 ml of TBA solution to each tube. Add 500 uL of milk sample to the falcon tube containing 2 ml TBA. Add 500 uL of prepared standards to the falcon tubes. Example: Add 500 uL of Tube 1 standard from its microfuge tube to the falcon tube containing 2 ml TBA. Place the samples in the water bath at 100 C for 15 minutes. Make sure the tubes are capped tight. Remove the tubes from the water bath and place them in ice for 5 minutes. Centrifuge the tubes at 1080×g for 10 minutes. After centrifugation, carefully and quickly transfer 200 uL of supernatant to a 96-well plate. For each standard and sample, transfer in duplicate. Read the absorbance at 532 nm. The absorbance values give MDA equivalents. Save the results in Excel to perform statistical analysis. Insert a linear equation from the standards curve.

Part C: Calculate the samples' MDA mean, % control, and standard deviation using the equation from the graph. The MDA results are expressed in concentration (uM).

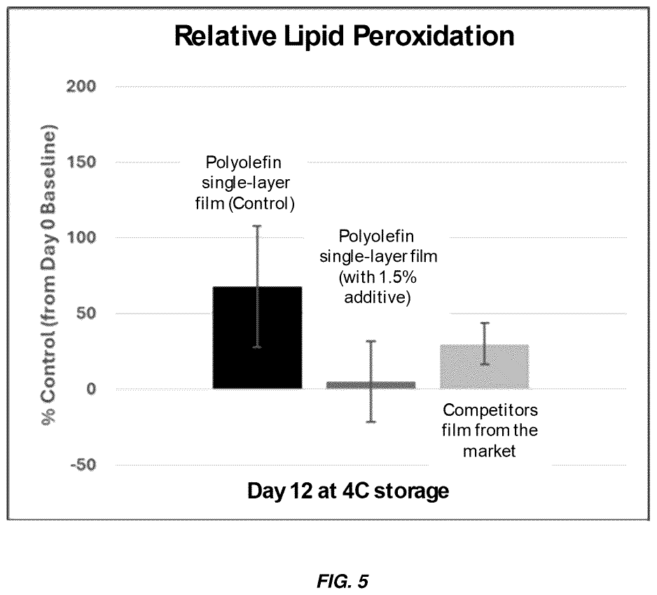

Example 5: Prototype plant-based milk containers produced from single layer films generated from polyolefin with a 1.5% (wt.) loading of 1:1 mixture of NCeONP/ZrO₂ additive (i.e. nanoporous cerium oxide macrostructures and zirconium oxide particles) were compared with a corresponding polyolefin film (ethylene-octene copolymer) without NCeONP/ZrO₂ and a film from a human breast milk storage container sold by Medela. As shown in FIG. 5, the lipid peroxidation levels of almond milk were evaluated at 4 °C over a 12 day period. As can be observed, the lowest relative lipid oxidation was present when almond milk was stored in a container made of polyolefin film containing a 1.5 % (wt.) loading of 1:1 mixture of NCeONP/ZrO₂ additive. The “% Control (from Day 0 Baseline)” represents lipid peroxidation levels as a percentage relative to the initial baseline (Day 0). Higher percentage values indicate increased lipid peroxidation, while lower percentage values show a reduction (improvement) in lipid oxidation. It should be noted that in FIGS. 5-12, the vertical lines with the horizontal ends represent nine (9) data points and therefore, the underlying bar graphs themselves represent the average values with reference to change from zero-day value and as can be observed, the average values are lower than the control indicating significant protection from lipid peroxidation.

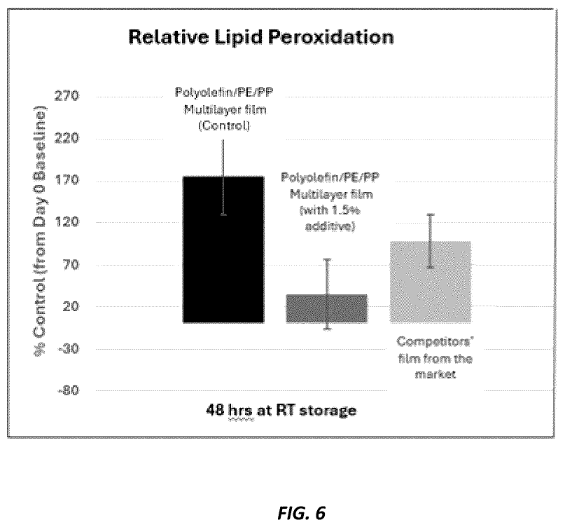

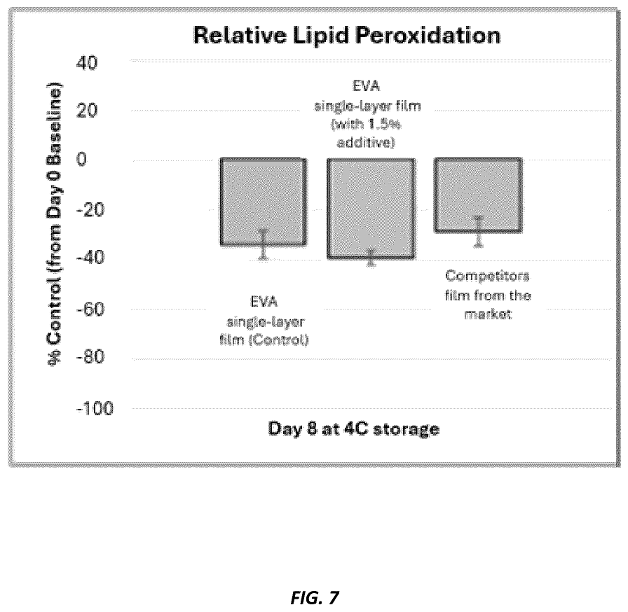

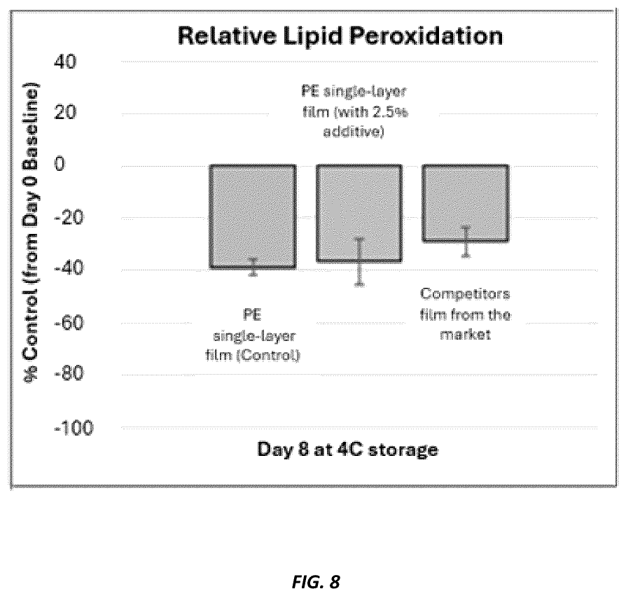

Example 6: Prototype milk bags produced from the multi-layer films generated from polyolefin/PE/PP with a 1.5% (wt.) loading of 1:1 mixture of NCeONP/ZrO₂ (i.e. nanoporous cerium oxide macrostructures and zirconium oxide particles) only in the contact layer were compared with the corresponding film without the additive and a film from an almond-milk container sold in the market. The polyolefin layer is preferably sourced from ethylene-octene copolymer and serves as the fluid contact layer containing the indicated 1.5 % (wt.) loading. As can be observed (FIG. 6), after 48 hours at room temperature the lowest relative lipid oxidation was present when almond milk was stored in a container made of polyolefin film containing a 1.5 % (wt.) loading of 1:1 mixture of NCeONP/ZrO₂ additive.

Example 7: Prototype plant-based milk containers produced from single-layer films generated from EVA (Ethylene Vinyl Acetate) with a 1.5% (wt.) loading of 1:1 mixture of NCeONP/ZrO₂ additive (i.e. nanoporous cerium oxide macrostructures and zirconium oxide particles) were compared with a corresponding EVA film without NCeONP/ZrO₂ and a film from a human breast milk container sold in the market by Medela. As shown in FIG. 7, the lipid peroxidation levels of almond milk were evaluated at 4 °C over an 8 day period. As can be observed, the lowest relative lipid oxidation was present when almond milk was stored in a container made of EVA film containing a 1.5 % (wt.) loading of 1:1 mixture of NCeONP/ZrO₂ additive. Interestingly, the control EVA film performed better than the container sold in the market but less effective than EVA film containing a 1.5 % (wt.) loading of 1:1 mixture of NCeONP/ZrO₂ additive. It should be appreciated in FIG. 7 that these are not absolute values but relative numbers, so that the higher the negative number the higher is the protection from lipid peroxidation.

Example 8: Prototype plant-based milk containers produced from single layer films generated from polyolefin (an ethylene-octene copolymer) with a 2.5% (wt.) loading of 1:1 mixture of NCeONP/ZrO₂ additive (i.e. nanoporous cerium oxide macrostructures and zirconium oxide particles) were compared with a corresponding neat polyolefin film without NCeONP/ZrO2 and a film from Medela's human milk bag an almond milk container sold in the market. As shown in FIG. 8, the lipid peroxidation levels of almond milk were evaluated at 4 °C over 8 days. As can be observed, the lowest relative lipid oxidation was present when almond milk was stored in a container made of neat polyolefin film without containing a 2.5 % (wt.) loading of 1:1 mixture of NCeONP/ZrO₂ additive. Interestingly, the control polyolefin film and polyolefin film containing a 2.5 % (wt.) loading of 1:1 mixture of NCeONP/ZrO2 additive performed better than the container sold in the market. It is contemplated that the results in FIG. 8 are due to batch to batch variations in the almonds utilized.

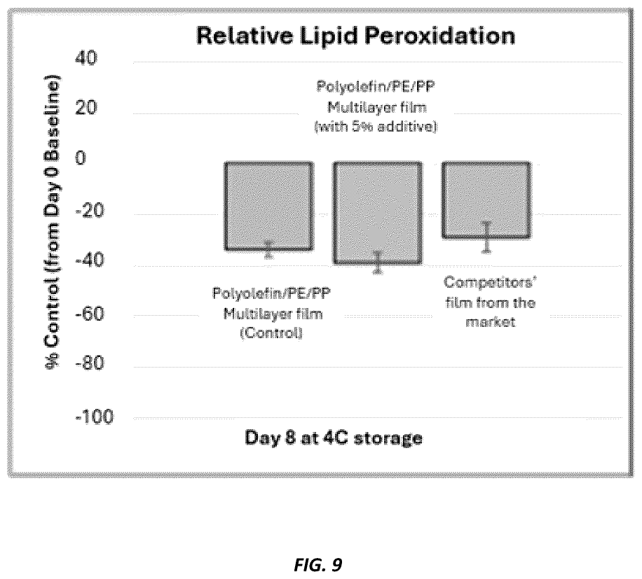

Example 9: Prototype milk bags produced from the multi-layer films generated from polyolefin/PE/PP as described in Example 6 with a 5.0 % (wt.) loading of 1:1 mixture of NCeONP/ZrO₂ (i.e. nanoporous cerium oxide macrostructures and zirconium oxide particles) only in the contact layer were compared with the corresponding film without the additive and a film from Medela's human milk bag sold in the market. As can be observed in FIG. 9, after 8 days at 4 C the lowest relative lipid oxidation was present when almond milk was stored in a container made of polyolefin film containing a 5.0 % (wt.) loading of 1:1 mixture of NCeONP/ZrO₂ additive.

Example 10: Preparation of fresh Oat milk: Commercially obtained rolled oats are cleaned and soaked in warm water for 30 minutes to remove the phytic acids. The soaked oat is blended at a medium-high speed for 30-45 seconds in 1:4 oats to water ratio (in cups) just enough to completely pulverize the oats without making them gummy. 80 g of oats were blended with 720 ml of DI water and the slurry was filtered through cheesecloth. The filtered oat milk was heated to 60 °C for 5 minutes to inactivate enzymes causing gumminess and the oat milk was placed into clean storage containers. For 4 °C experiments, the oat milk was stored in a refrigerator immediately. For RT experiments, the oat milk was kept at room temperature (RT).

Example 11: The TBARS assay on the oat milk stored for 2 Days at RT and 8 days at 4 C was carried out as in Example 4 for Almond milk.

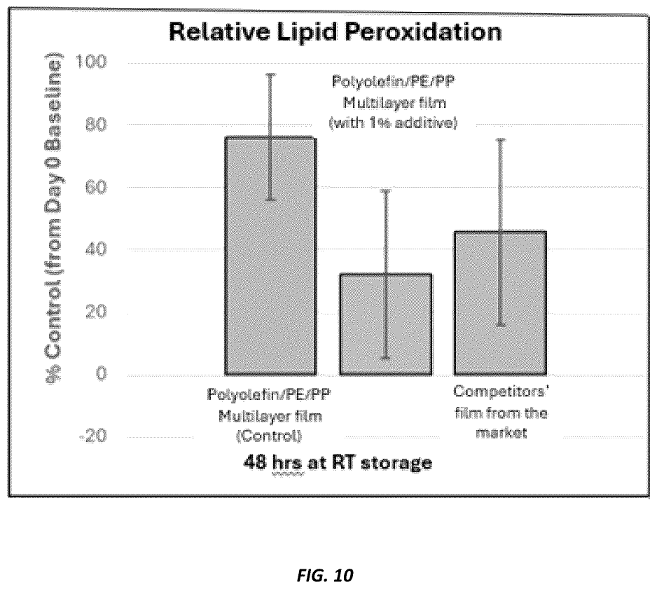

Example 12: Prototype milk bags produced from the multi-layer films generated from polyolefin/PE/PP as described in Example 6 with a 1.0% loading of 1:1 mixture of NCeONP/ZrO₂ (i.e. nanoporous cerium oxide macrostructures and zirconium oxide particles) only in the contact layer were compared with the corresponding film without the additive and a film from Medela's human breast milk storage bag sold in the market. As can be observed in FIG. 10, after 48 hours at room temperature the lowest relative lipid oxidation was present when oat milk was stored in a container made of polyolefin film containing a 1.0 % (wt.) loading of 1:1 mixture of NCeONP/ZrO₂ additive.

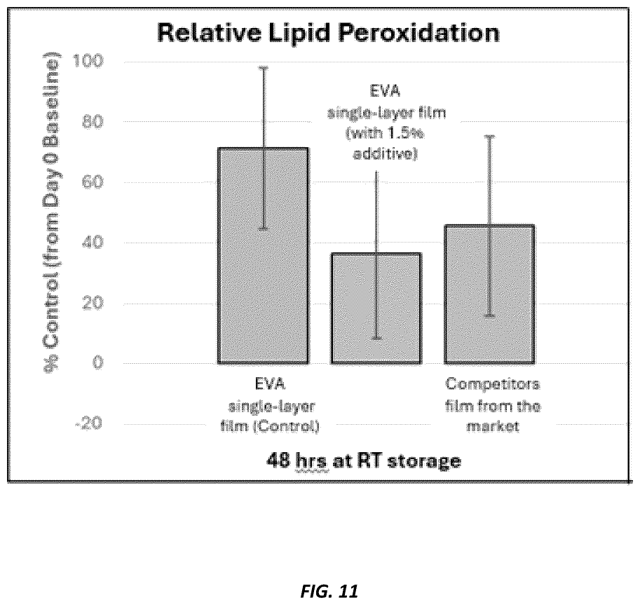

Example 13: Prototype plant-based milk containers produced from single layer films generated from EVA (Ethylene Vinyl Acetate) with a 1.5% (wt.) loading of 1:1 mixture of NCeONP/ZrO₂ additive (i.e. nanoporous cerium oxide macrostructures and zirconium oxide particles) were compared with a corresponding EVA film without NCeONP/ZrO₂ and a film from human breast milk bag produced by Medela sold in the market. As shown in FIG. 11, the lipid peroxidation levels of oat milk were evaluated at RT over a 2 day period. As can be observed, the lowest relative lipid oxidation was present when oat milk was stored in a container made of EVA film containing a 1.5 % (wt.) loading of 1:1 mixture of NCeONP/ZrO2 additive.

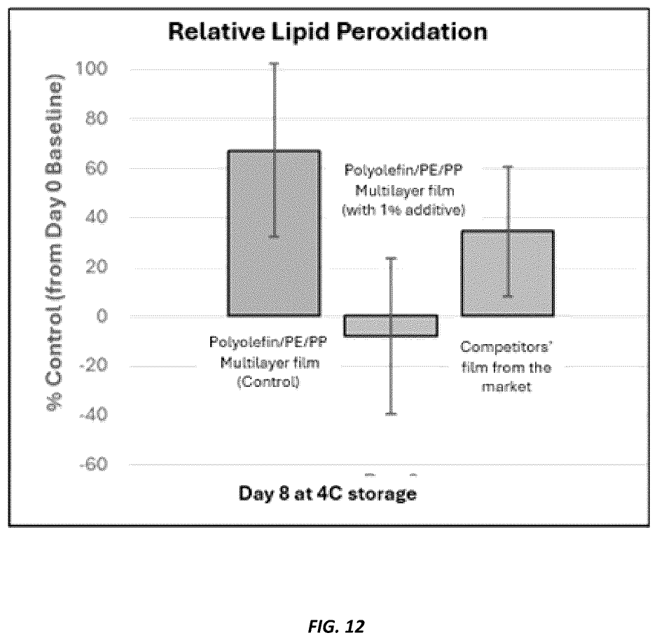

Example 14: Prototype plant-based milk containers produced from a multilayer film generated from with polyolefin/PE/PP as described in Example 6 at a 1.0 % (wt.) loading of 1:1 mixture of NCeONP/ZrO₂ additive (i.e. nanoporous cerium oxide macrostructures and zirconium oxide particles) were compared with a corresponding neat polyolefin film without NCeONP/ZrO₂ and a film from a milk container (Medela) sold in the market. As shown in FIG. 12, the lipid peroxidation levels of oat milk were evaluated at 4 °C over 8 days. As can be observed, the lowest relative lipid oxidation was present when oat milk was stored in a container made of the described multilayer film containing a 1.0 % (wt.) loading of 1:1 mixture of NCeONP/ZrO₂ additive.

What is claimed is:

1. A method of increasing the shelf life of plant-based milk in a container comprising:
providing a container comprising polymeric film containing at least one of cerium oxide nanoparticles, nanoporous cerium oxide nanoparticle macro-structures, or zirconium dioxide nanoparticles; and
storing plant-based milk in said container.

2. The method of claim 1, wherein said polymeric film is a single-layer film.

3. The method of claim 1, wherein said polymeric film is a multi-layer film including a layer of film in contact with said plant-based milk, wherein said layer of film in contact with said plant-based milk contains said at least one of cerium oxide nanoparticles, nanoporous cerium oxide nanoparticle macro-structures, or zirconium dioxide nanoparticles.

4. The method of claim 1, wherein said at least one of cerium oxide nanoparticles, nanoporous cerium oxide nanoparticle macro-structures, or zirconium dioxide nanoparticles is dispersed in said polymeric film.

5. The method of claim 1, wherein said at least one of cerium oxide nanoparticles, nanoporous cerium oxide nanoparticle macro-structures, or zirconium dioxide nanoparticles is coated on said polymeric film.

6. The method of claim 1, wherein said nanoporous cerium oxide nanoparticle macro-structures have a pore diameter in the range of 10 nm to 1100 nm.

7. The method of claim 1, wherein said nanoporous cerium oxide nanoparticle macro-structures have a diameter in the range of 50 nm to 30,000 nm.

8. The method of claim 1, wherein said polymer film has a thickness in the range of 10.0 microns to 10.0 mm.

9. The method of claim 1, wherein said polymer film is selected from the group consisting of polyolefins, polyethylene-co-vinyl acetate, poly(vinyl chloride), polyester, polyamide, cellulose, polylactic acid, polysiloxane, aromatic polyketones, polyimide, hydrogel or polyurethane.

10. The method of claim 1, wherein said at least one of said cerium oxide nanoparticles or cerium oxide nanoparticle macro-structures or zirconium dioxide nanoparticles are present in said polymer film at a level of 0.01 wt. % to 10.0 wt. %.

11. The method of claim 1, wherein two or more of said cerium oxide nanoparticles, cerium oxide nanoparticle macro-structures or zirconium dioxide nanoparticles are mixed and present at a maximum combined level in said polymer film at a level of 0.01 wt. % to 10.0 wt. %.

12. The method of claim 1, wherein said plant-based milk experiences lipid peroxidation and said polymer film containing at least one of cerium oxide nanoparticles, nanoporous cerium oxide nanoparticle macro-structures or zirconium dioxide nanoparticles, reduces lipid peroxidation either due to free radical scavenging or preventing oxidation by peroxides by converting them into oxygen and water.

13. The method of claim 1, wherein said polymer film containing at least one of cerium oxide nanoparticles, nanoporous cerium oxide nanoparticle macro-structures, or zirconium dioxide nanoparticles scavenge free radicals.

14. The method of claim 1, wherein said polymer film containing at least one of cerium oxide nanoparticles, nanoporous cerium oxide nanoparticle macro-structures, or zirconium dioxide nanoparticles comprises a mixture of cerium oxide nanoparticles and zirconium dioxide nanoparticles.

15. The method of claim 1, wherein said polymer film containing at least one of cerium oxide nanoparticles, nanoporous cerium oxide nanoparticle macro-structures, or zirconium dioxide nanoparticles comprises a mixture of nanoporous cerium oxide nanoparticle macro-structures and zirconium dioxide nanoparticles.

16. The method of claim 11, wherein said mixture of nanoporous cerium oxide nanoparticle macro-structure and zirconium oxide nanoparticles comprises a 1:10 to 10:1 mixture of nanoporous cerium oxide nanoparticle macrostructures and zirconium dioxide nanoparticles.

17. The method of claim 11, wherein said mixture of nanoporous cerium oxide nanoparticle macro-structure and zirconium oxide nanoparticles comprises a 1:1 mixture of nanoporous cerium oxide nanoparticle macrostructures and zirconium dioxide nanoparticles.

18. The method of claim 13, wherein said nanoporous cerium oxide nanoparticle macro-structures have a pore size in the range of 10 nm to 1100 nm.

19. The method of claim 13, wherein said nanoporous cerium oxide nanoparticle macro-structures have a diameter in the range of 50 nm to 30,000 nm.

20. The method of claim 13, wherein said cerium oxide nanoparticles have a diameter in the range of 10 nm to 100 nm.

21. The method of claim 13, wherein said zirconium dioxide nanoparticles have a diameter in the range of 10.0 nm to 2000.0 nm.

22. The method of claim 1, wherein said plant-based milk comprises almond milk, coconut milk, oat milk, cashew milk, rice milk or soy milk.

23. The method of claim 1, further including a preservative in said plant-based milk stored in said container wherein said preservative is a chemical compound that extends shelf-life.

24. A method of storing plant-based milk comprising
providing a container comprising polymeric film, metal or paperboard including a contact layer having at least one of cerium oxide nanoparticles, nanoporous cerium oxide nanoparticle macro-structures, or zirconium dioxide nanoparticles; and
storing plant-based milk in said container in contact with said contact layer.

25. A method of storing plant-based milk comprising:
providing a container comprising polymeric film including a polymeric film insert having at least one of cerium oxide nanoparticles, nanoporous cerium oxide nanoparticle macro-structures, or zirconium dioxide nanoparticles; and
storing plant-based milk in said container in contact with said insert.

26. A container for plant-based milk comprising a plant-based milk storage surface comprising at least one of cerium oxide nanoparticles, nanoporous cerium oxide nanoparticle macrostructures or zirconium dioxide nanoparticles present in an amount effective to increase the shelf-life of plant-based milk when plant-based milk is stored in contact with the plant-based milk storage surface.
